(19) United States
(12) Patent Application Publication
(10) Pub. No.: US 2026/0057189 A1
(43) Pub. Date: Feb. 26, 2026

(54) INFORMATION PROCESSING APPARATUS AND INFORMATION PROCESSING METHOD

(71) Applicant: Toshiba Tec Kabushiki Kaisha, Tokyo (JP)

(72) Inventor: Takesi KAWAGUTI, Mishima Shizuoka (JP)

(21) Appl. No.: 19/248,402

(22) Filed: Jun. 24, 2025

(30) Foreign Application Priority Data
Aug. 20, 2024 (JP) 2024-139130

(51) Int. Cl. G06F 40/40

(52) U.S. Cl. CPC G06F 40/40

(57) ABSTRACT

According to one embodiment, an information processing apparatus includes a storage unit, a communication unit, and a control unit. The control unit is configured to receive a query text via the communication unit, then generate a prompt based on the query text. The control unit also acquires present load status information corresponding to a current workload of the control unit. The number of generative AI models to which the generated prompt is to be input is determined based at least in part on the present load status information. The control unit receives a response text to the prompt from the determined number of generative AI models, and then outputs a query response text via the communication unit. The query response text reflects each received response text. In some examples, the number of times the prompt is input to a generative AI model may be set based on the current workload.

### CROSS-REFERENCE TO RELATED APPLICATION

This application is based upon and claims the benefit of priority from Japanese Patent Application No. 2024-139130, filed on Aug. 20, 2024, the entire contents of which are incorporated herein by reference.

### FIELD

Embodiments described herein relate generally to an information processing apparatus and an information processing method.

### BACKGROUND

In recent years, a natural language processing system using a generative artificial intelligence (AI), such as a large language model (LLM), that can generate a natural language sentence has appeared.

Such a large language model generates and outputs a response text related to a query received from a user. In a machine equipped with such a large language model, since computing resources are required to be utilized when the response text is generated, there is a problem that speed and efficiency of generating the response text decreases due to a resource shortage such as when the machine is under a high usage load.

### BRIEF DESCRIPTION OF THE DRAWINGS

FIG. 1 is a schematic diagram of an information processing system according to a first embodiment.

FIG. 2 is a block diagram of an edge server according to a first embodiment.

FIG. 3 shows an example of a data configuration of a load information table according to a first embodiment.

FIG. 4 is a block diagram of an edge device according to a first embodiment.

FIG. 5 depicts a functional configuration of an edge server and an edge device according to a first embodiment.

FIG. 6 is a flowchart of processing performed by an edge server and an edge device according to a first embodiment.

FIG. 7 is a flowchart showing an example of processing performed by an edge server and an edge device according to a first modification of a first embodiment.

FIG. 8 is a block diagram of an edge server according to a second embodiment.

FIG. 9 shows an example of a data configuration of a user master according to a second embodiment.

FIG. 10 depicts a functional configuration of an edge server and an edge device according to a second embodiment.

FIG. 11 is a flowchart of processing performed by an edge server and an edge device according to a second embodiment.

### DETAILED DESCRIPTION

An object of the disclosure is to provide an information processing apparatus and an information processing method that can perform control to efficiently generate a response to a query from a user according to a load status.

In general, according to one embodiment, an information processing apparatus includes a storage unit, a communication unit, and a control unit. The control unit is configured to: receive a query text via the communication unit; generate a prompt based on the query text; acquire present load status information corresponding to a current workload of the control unit; determine a number of generative AI models to which the generated prompt is to be input based at least in part on the present load status information; receive a response text from the determined number of generative AI models; and output a query response text via the communication unit, the query response text reflecting each received response text.

Hereinafter, certain example embodiments of an information processing apparatus and an information processing method will be described with reference to the drawings. The disclosure is not limited to these specific example embodiments.

### First Embodiment

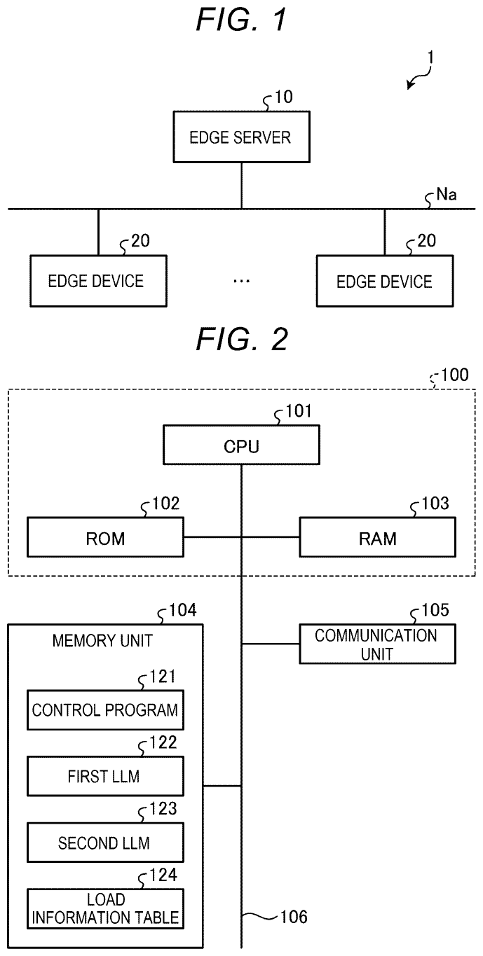

FIG. 1 is a schematic diagram of an information processing system 1 according to a first embodiment. As shown in FIG. 1, the information processing system 1 includes an edge server 10 and an edge device 20. The information processing system 1 is implemented, for example, in a store such as a supermarket or a department store (hereinafter, simply referred to as a store). The information processing system 1 has a function of responding to a query about merchandise in the store. The edge server 10 and the edge device 20 are communicably connected in a wired or wireless manner.

The edge server 10 is an example of an information processing apparatus. The edge server 10 is, for example, a server apparatus provided in a local environment connected to the edge device 20 in a wired manner or in a cloud environment. The edge server 10 generates a response text based on a query (hereinafter, also referred to as a query text) received from the edge device 20. Here, the query is a text including various query contents input from a user. The response text is a text including a response to the query contents or the like in the query.

Specifically, upon receiving the query from the edge device 20, the edge server 10 acquires load information indicating a present (current) load status of the edge server 10, and then determines the number of generative AIs to be used for generating the response text according to the acquired load information. In this context, the load information indicates a present (current) workload of the edge server 10 or a control unit or processor therein or thereof. Ultimately, the edge server 10 transmits the response text generated using the determined number of generative AIs to the edge device 20. Additional details about the load information will be described below.

The edge device 20 is, for example, a terminal device, such as a PC, accessed by a user of the information processing system 1. The edge device 20 exchanges various types of information with the edge server 10. In some examples, the edge device 20 may be a mobile terminal such as a smartphone, or a tablet terminal.

Specifically, the edge device 20 transmits a query, as input by a user operation, to the edge server 10. Upon receiving the response text from the edge server 10, the edge device 20 presents the received response text to the user.

In the present embodiment, the edge server 10 is implemented as a single apparatus, but in other examples may be implemented as a plurality of apparatuses. In some examples, edge server 10 and edge device 20 may be sub-parts of an integrated apparatus.

A hardware configuration of the edge server 10 will be described. FIG. 2 is a block diagram showing an example of the hardware configuration of the edge server 10 according to the first embodiment.

As shown in FIG. 2, the edge server 10 includes a central processing unit (CPU) 101, which is one example of a processor, a read only memory (ROM) 102, a random access memory (RAM) 103, a memory unit 104, a communication unit 105, and the like.

The CPU 101 is an example of a processor and performs overall control of each unit in the edge server 10. The ROM 102 stores various programs. The RAM 103 is a workspace for loading programs and various types of data.

The memory unit 104 is a non-volatile memory such as a hard disc drive (HDD) or a flash memory in which stored information is retained even when a power supply is turned off. The memory unit 104 includes a control program 121, a first LLM 122, a second LLM 123, and a load information table 124. The total number of LLMs provided in the memory unit 104 is not limited to the shown example.

The control program 121 is a control (software) program for controlling the edge server 10. The CPU 101, the ROM 102, the RAM 103, and the memory unit 104 are connected to one another via a bus 106. The CPU 101, the ROM 102, and the RAM 103 constitute a control unit 100. That is, the control unit 100 executes the control processing for the edge server 10 by the CPU 101 operating according to the control program 121 stored in the ROM 102 or the memory unit 104 and loaded into the RAM 103.

The first LLM 122 and the second LLM 123 are generative AIs for generating a text response. The first LLM 122 and the second LLM 123 are, for example, large language models (LLM). The first LLM 122 and the second LLM 123 receive input of a text (also referred to as a prompt) generated based on the query from the user, and then generate the response text corresponding to the query. In the present embodiment, an LLM is used as the generative AI, but the generative AI to be used is not limited to an LLM and other types may be adopted as long as response text can be generated therefrom. Hereinafter, an LLM is also more simply referred to as a model.

The first LLM 122 and the second LLM 123 are constructed by, for example, a known deep learning technique or the like, and generate and output the response text based on conditions, such as the particular query content in the query from the user. That is, the response text provided in view of the prompt reflecting or incorporating the user's submitted query.

A known-type generative AI can be applied to both the first LLM 122 and the second LLM 123. In some examples, the first LLM 122 and the second LLM 123 may be generative AIs of the same type and version. In other examples, different generative AIs (of different types or different versions of the same type) may be adopted for the first LLM 122 and the second LLM. In a particular example, the first LLM 122 and the second LLM 123 may be generative AIs of different types or versions that are considered to have different respective accuracies with respect to generating a response text. In the present embodiment, the first LLM 122 and the second LLM 123 are the same type unless otherwise specified.

The first LLM 122 and the second LLM 123 may use, for example, a known natural language processing technique such as retrieval-augmented generation (RAG), receive input of a prompt generated based on the user query and supplementary information acquired from an external storage apparatus, and generate a response text according to the user query and the supplementary information. In such a case, the external storage apparatus may store information about each item of merchandise sold in the store.

The first LLM 122 and the second LLM 123 may be subjected to fine tuning and specialized for use in the information processing system 1. For example, such fine-tuning may change the content of a response or may change phrasing, vocabulary, and/or tone used in the response. For example, the first LLM 122 and the second LLM 123 may have been trained for specific phrasing, such as favored writing styles and response endings tailored to the information processing system 1.

The load information table 124 is a data table or a database for tracking the load information for the edge server 10 and the number of LLMs (e.g., first LLM 122 and second LLM 123 or just one or the other) to be used for generating the response text. FIG. 3 shows an example of a data configuration of the load information table 124 according to the first embodiment. As shown in FIG. 3, the load information table 124 stores load information about the edge server 10 load levels in association with the number of models to be used in view of the load level.

The load information can be information representing various indicators of a load status or current workload of the edge server 10. For example, the load information may be or include a usage rate of the CPU 101 in the edge server 10, the number of concurrent (simultaneous) users of the edge server 10, and/or the number of prompts presently waiting for the generation of a response text.

The entry in the number of models column provided the number of models to be used for generating the response text for the corresponding load level. For example, when the CPU usage rate is 50% or more (in other words, when the edge server 10 is in a high-load status) the corresponding number of models to be used is “1” in FIG. 3. As such, when in the high-load status, edge server 10 inputs a prompt to just one of the first LLM 122 and the second LLM 123. When the CPU usage rate is less than 50% (in other words, when the edge server 10 is in a low-load status) the corresponding number of models to be used is “2” in FIG. 3. As such, when in the low-load status, edge server 10 inputs the prompt to both the first LLM 122 and the second LLM 123. As noted, the total possible number of models to be used is not limited to two, and load status increments and total number of models to be used can be set according to the total number of LLMs provided in the edge server 10.

Referring back to FIG. 2, the control unit 100 is connected to the communication unit 105 via the bus 106. The communication unit 105 is a communication interface such as a LAN I/F and is connected to a network Na. The communication unit 105 transmits and receives various types of information to and from the edge device 20 via the network Na. The communication unit 105 can be connected to a network such as the Internet or another information processing apparatus.

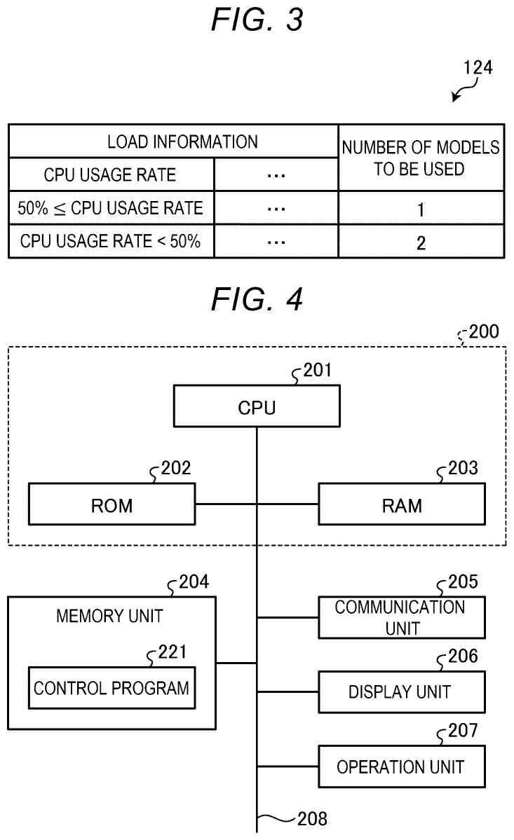

Next, a hardware configuration of the edge device 20 will be described. FIG. 4 is a block diagram showing an example of the hardware configuration of the edge device 20 according to the first embodiment.

As shown in FIG. 4, the edge device 20 includes a CPU 201, a ROM 202, a RAM 203, a memory unit 204, a communication unit 205, a display unit 206, an operation unit 207, and the like.

The CPU 201 performs overall control of each unit in the edge device 20. The ROM 202 stores various programs. The RAM 203 is a workspace for loading programs and various types of data.

The memory unit 204 is a non-volatile memory such as an HDD or a flash memory in which stored information is retained even when the power supply is turned off. The memory unit 204 includes a control program 221.

The control program 221 is a control (software) program for controlling the edge device 20. The CPU 201, the ROM 202, the RAM 203 and the memory unit 204 are connected to one another via a bus 208. The CPU 201, the ROM 202, and the RAM 203 constitute a control unit 200. That is, the control unit 200 executes the control processing for the edge device 20 by the CPU 201 operating according to the control program 221 stored in the ROM 202 or the memory unit 204 and loaded into the RAM 203.

The control unit 200 is connected to the communication unit 205, the display unit 206, and the operation unit 207 via the bus 208.

The communication unit 205 is a communication interface such as a LAN I/F and is connected to the network Na. The communication unit 205 transmits and receives various types of information to and from, for example, the edge server 10 via the network Na. The communication unit 205 can be connected to a network such as the Internet or another information processing apparatus under.

The display unit 206 is a display device such as a liquid crystal display (LCD). The display unit 206 displays various types of information under control of the CPU 201.

The operation unit 207 receives various types of input from the user. The operation unit 207 includes, for example, a keyboard and a pointing device. The operation unit 207 may be a touch panel integrated with the display unit 206.

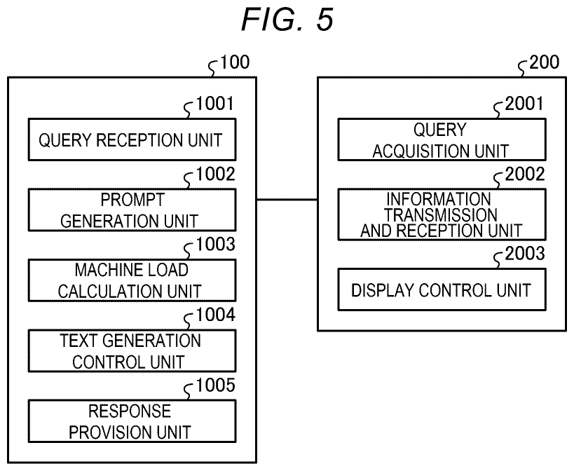

Next, functional aspects of the edge server 10 and the edge device 20 will be described. FIG. 5 is a block diagram depicting a functional configuration of the edge server 10 and the edge device 20 according to the first embodiment.

As shown in FIG. 5, the control unit 100 provides the functions of a query reception unit 1001, a prompt generation unit 1002, a machine load calculation unit 1003, a text generation control unit 1004, and a response provision unit 1005.

Specifically, the control unit 100 (CPU 101) executes the control program 121 stored in the memory unit 104 to implement the above-described functional units. In this embodiment, functional units are a software configuration implemented by cooperation between the processor (CPU 101) and the software program(s) in the edge server 10, but is not limited thereto, and certain described functions may be implemented as a hardware configuration in which a part or all of the described functions are implemented by a dedicated circuit or the like.

The query reception unit 1001 receives information from the edge device 20. Specifically, the query reception unit 1001 receives the query transmitted from the edge device 20.

The prompt generation unit 1002 generates the prompt. Specifically, the prompt generation unit 1002 generates the prompt based on the query received by the query reception unit 1001.

Here, the prompt includes instruction text for instructing aspects related to the format and details to be incorporated into the response text to be generated. For example, the prompt preferably includes specific instruction contents such as “output a response according to a gist of the user query”. The prompt may also be generated by selection from among a plurality of prompt templates or types based on the language or content of the query or the like.

The machine load calculation unit 1003 is an example of a first acquisition unit. The machine load calculation unit 1003 acquires the load information related to the edge server 10. Here, the load information acquired by the machine load calculation unit 1003 is, for example, an indicator value such as the CPU usage rate defined in the load information table 124.

Specifically, in this example, the machine load calculation unit 1003 acquires the current usage rate of the CPU 101 as the load information. In some examples, the machine load calculation unit 1003 may acquire the number of users presently using the edge server 10 and/or the number of prompts waiting for response text generation. The various load information (indicators) may each be used separately from the usage rate of the CPU 101 or in combination with one another.

The machine load calculation unit 1003 may set an interval timing for acquiring load information as a constant or fixed time interval (e.g., an interval of 10 seconds or the like). In some examples, the machine load calculation unit 1003 may cooperate with the text generation control unit 1004 to acquire the load information whenever an instruction is received from the text generation control unit 1004.

The text generation control unit 1004 is an example of an input unit, a second acquisition unit, and a determination unit. The text generation control unit 1004 sets the number of LLMs to be used according to the load information acquired by the machine load calculation unit 1003. The text generation control unit 1004 generates the response text to the query (prompt) using the set or selected number of LLMs.

Specifically, the text generation control unit 1004 refers to the load information table 124 and acquires the number of models to be used in view of the corresponding load information acquired by the machine load calculation unit 1003. When the number of models to be used is “1”, the text generation control unit 1004 inputs the prompt to either the first LLM 122 or the second LLM 123. Then, the text generation control unit 1004 acquires the response text output by whichever of the first LLM 122 or the second LLM 123 to which the prompt was input.

If the number of models to be used is “2”, the text generation control unit 1004 inputs the prompt to the first LLM 122 and the second LLM 123. Then, the text generation control unit 1004 acquires a first response text and a second response text as respectively output by the first LLM 122 and the second LLM 123.

The text generation control unit 1004 may adopt any method for selecting between the models when less than all are to be used according to the current load information. For example, the text generation control unit 1004 may select between the first LLM 122 and the second LLM 123 randomly, in turn (in a round-robin sequence manner), or by selecting a preset model. For example, if the first LLM 122 and the second LLM 123 differ in model operating performance in some manner, the text generation control unit 1004 may select the model requiring a lower processing load, which may be the model with lower accuracy.

As described above, by changing the number of models to be used according to the load information, it is possible to prevent the edge server 10 from being in a constantly high-load status and to prevent speed and efficiency in generating the response text from decreasing due to a resource shortage. In other words, it is possible to perform control to more efficiently generate a response to a query from the user according to the current load status.

The time at which the load information is checked may be the time at which the query transmitted from the edge device 20 is received. When the text generation control unit 1004 controls the timing for acquiring the load information, the text generation control unit 1004 may transmit an instruction to the machine load calculation unit 1003 to cause the machine load calculation unit 1003 to acquire the load information when the query is received from the edge device 20.

The response provision unit 1005 provides the user with the response text generated in response to the query. Specifically, the response provision unit 1005 transmits the response text generated by the text generation control unit 1004 to the edge device 20.

When there are multiple response texts acquired by the text generation control unit 1004 for the same query (i.e., multiple models have been used), the response provision unit 1005 may provide the multiple response texts directly or may merge the response texts into a merged response text before provision to the user.

In present context, a case where there are a plurality of response texts means the text generation control unit 1004 inputs the prompt to both the first LLM 122 and the second LLM 123 to obtain a response text from each. Merging the response texts means, for example, combining multiple response texts into one single response text. The merging method is not particularly limited, and various methods can be adopted.

For example, the text generation control unit 1004 may form one response text by deleting duplicate portions from the multiple response texts. The text generation control unit 1004 may also count words appearing in common in the different response texts and then extract portions in which the common or shared words to form one response text.

The control unit 200 of the edge device 20 includes a query acquisition unit 2001, an information transmission and reception unit 2002, and a display control unit 2003 as functional aspects.

Specifically, the control unit 200 (CPU 201) of the edge device 20 executes the control program 221 stored in the memory unit 204 to implement the described functional aspects. In this present embodiment, each functional configuration is a software configuration implemented by cooperation between the processor and a program in the edge device 20, but is not limited thereto. In other examples, described functions may be provided a hardware configuration in which a part or all of the functions are implemented by a dedicated circuit or the like.

The query acquisition unit 2001 acquires information received by the edge device 20 from the user. In other words, the query acquisition unit 2001 receives information input by the user. For example, the query acquisition unit 2001 acquires a query input by a user operation performed via the operation unit 207.

The information transmission and reception unit 2002 transmits and receives various types of information to and from the edge server 10 via the communication unit 205. For example, the information transmission and reception unit 2002 transmits the query acquired by the query acquisition unit 2001 to the edge server 10. The information transmission and reception unit 2002 also receives the response text from the edge server 10.

The display control unit 2003 displays various types of information on the display unit 206. For example, the display control unit 2003 displays a screen for supporting query input on the display unit 206. The display control unit 2003 displays, on the display unit 206, the response text when acquired by the information transmission and reception unit 2002, that is, the response text to the query is displayed.

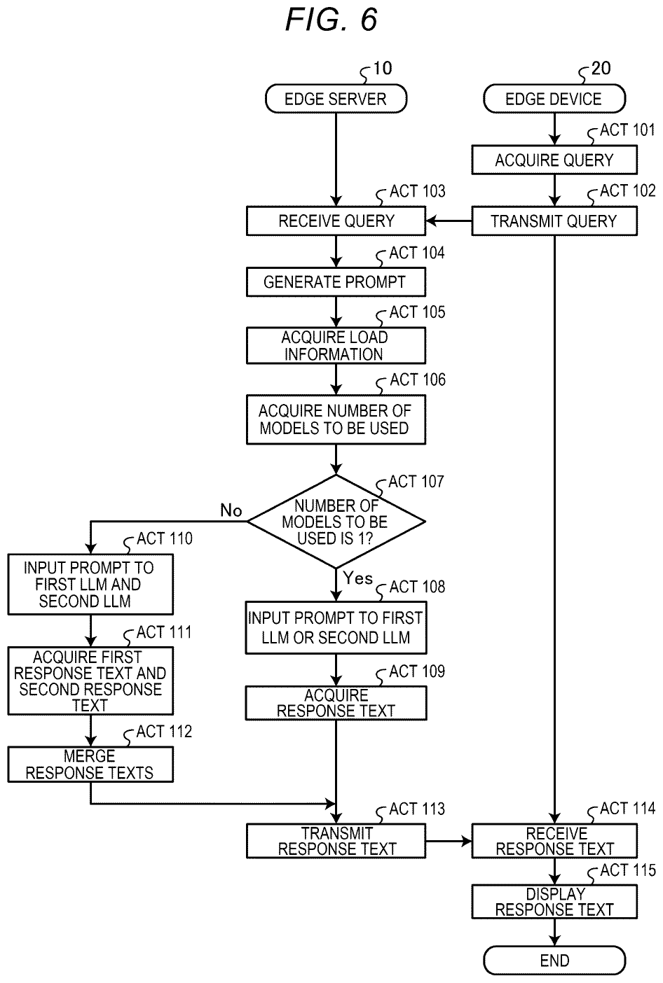

Next, control processing of the edge server 10 and the edge device 20 will be described with reference to FIG. 6.

FIG. 6 is a flowchart showing an example of processing performed by the edge server 10 and the edge device 20 according to the first embodiment. FIG. 6 shows a processing example when a response text to the query acquired by the edge device 20 is generated by the edge server 10 and then provided to the edge device 20.

First, the query acquisition unit 2001 acquires the query input by the user operation (ACT 101). Next, the information transmission and reception unit 2002 transmits the acquired query to the edge server 10 (ACT 102).

The query reception unit 1001 of the edge server 10 receives the query transmitted from the edge device 20 (ACT 103). Next, the prompt generation unit 1002 generates a prompt based on or incorporating the received query (ACT 104).

Subsequently, the machine load calculation unit 1003 of the edge server 10 acquires the usage rate of the CPU 101 as the load information (ACT 105). Next, the text generation control unit 1004 refers to the load information table 124 and acquires the number of models to be used according to the acquired load information (ACT 106). Next, the text generation control unit 1004 determines whether the acquired number of models to be used is “1” (ACT 107).

When the number of models to be used is “1” (ACT 107; Yes), the text generation control unit 1004 inputs the prompt to one of the first LLM 122 or the second LLM 123 (ACT 108). The text generation control unit 1004 then acquires the response text output by whichever of the first LLM 122 or the second LLM 123 to which the prompt was input (ACT 109). Then, the control unit 100 proceeds with the processing to ACT 113.

When the number of models to be used is “2” (ACT 107; No), the text generation control unit 1004 inputs the prompt to both the first LLM 122 and the second LLM 123 (ACT 110). The text generation control unit 1004 then acquires the first response text and the second response text as respectively output by the first LLM 122 and the second LLM 123 (ACT 111). Then, the response provision unit 1005 acquires a response text obtained by merging the first response text and the second response text (ACT 112).

Subsequently, the response provision unit 1005 ultimately transmits a response text to the edge device 20 (ACT 113).

The information transmission and reception unit 2002 of the edge device 20 receives the response text from the edge server 10 (ACT 114). Then, the display control unit 2003 displays the response text on the display unit 206 (ACT 115).

In the present example, the edge server 10 (one example of an information processing apparatus) includes: the first acquisition unit configured to acquire the load information indicating the load status of the information processing apparatus; the input unit configured to input the prompt including the query text, which is input by the user, to a generative AI to generate a response text for the prompt; the second acquisition unit configured to acquire the response text generated by the generative AI; the provision unit configured to provide, to the user, the response text as acquired by the second acquisition unit; and the determination unit configured to determine, according to the load status, the number of generative AIs to which the prompt is to be input or, alternatively, the number of times the prompt is to be input to a generative AI. The input unit inputs the prompt based on the number of generative AIs or the number of times as determined by the determination unit.

The edge server 10 generates the prompt based on the user query to include or reflect the query content input by the user, and determines the number of LLMs to which the prompt is to be input according to the load information/load status of the edge server 10. Then, the edge server 10 acquires the response text output by the one or more determined LLMs.

Accordingly, the edge server 10 performs control such that only one LLM is used to generate a response text when the edge server 10 is in a high-load status, and a plurality of LLMs are used to generate response texts when the edge server 10 is in a low-load status. By changing the number of models to be used according to the load information, it is possible to prevent the edge server 10 from being in a constantly high-load status, and to prevent speed and efficiency in generating a response text from decreasing due to a resource shortage. In other words, it is possible to perform control to more efficiently generate a response to a query from a user according to the current load status.

The above-described embodiment can be appropriately modified and implemented by changing a part of the configurations or functions of each of the above-described apparatuses. Therefore, several modifications according to the above-described embodiment will be described hereinafter as other embodiments. In the following, differences from the above-described embodiment will be mainly described, and the same reference symbols will be used for those configurations and aspects that are the same as those already described, and additional description thereof may be omitted as appropriate. In addition, the modifications described below may be individually implemented or may be implemented in combination with one another as appropriate.

### First Modification

In an embodiment, the edge server 10 adjusts the number of LLMs to be used according to the load information. In this modification, the edge server 10 adjusts the number of times the prompt is input to an LLM, that is, the number of times of processing related to the generation of the response text.

In the first modification, memory unit 104 of the edge server 10 may include a single LLM, in other words, a case where the memory unit 104 of the edge server 10 stores just the first LLM 122 will be described. The first modification is configured to generate the response text from multiple viewpoints by inputting the same query (prompt) to the LLM a plurality of times while changing a condition or the like in the prompt each time.

In this modification, the load information table 124 stores the number of trials instead of the number of models to be used. Here, the number of trials is the number of times the prompt is to be input to the LLM, that is, the number of times a response text is to be generated for the same user query.

The number of trials is preferably set to be smaller when the edge server 10 is in a higher-load status. For example, when the CPU usage rate is equal to or more than 50%, the number of trials is set to “1”, and when the CPU usage rate is less than 50%, the number of trials is set to “3”.

The text generation control unit 1004 according to the first modification refers to the load information table 124 and acquires the number of trials corresponding to the load information acquired by the machine load calculation unit 1003. The text generation control unit 1004 inputs the prompt to the first LLM 122. Then, the text generation control unit 1004 updates the number of trials remaining in the RAM 103 until the number of trials to be used is satisfied.

When a response text output by the first LLM 122 is acquired, the text generation control unit 1004 temporarily stores the acquired response text in the RAM 103 as an x-th response text (x: the number of text input times). When the number of text input times stored in the RAM 103 does not reach the number of trials, the text generation control unit 1004 inputs the prompt to the first LLM 122 again.

Here, a prompt is repeatedly input to the first LLM 122, however, the prompt may be input with a changed condition or variation each time.

The response provision unit 1005 according to the first modification transmits response text generated by the text generation control unit 1004 to the edge device 20. Specifically, once the number of text input times stored in the RAM 103 matches the number of trials, the text generation control unit 1004 acquires all response texts stored in the RAM 103 and generates a response text obtained by merging the response texts. The response provision unit 1005 transmits the merged response text to the edge device 20.

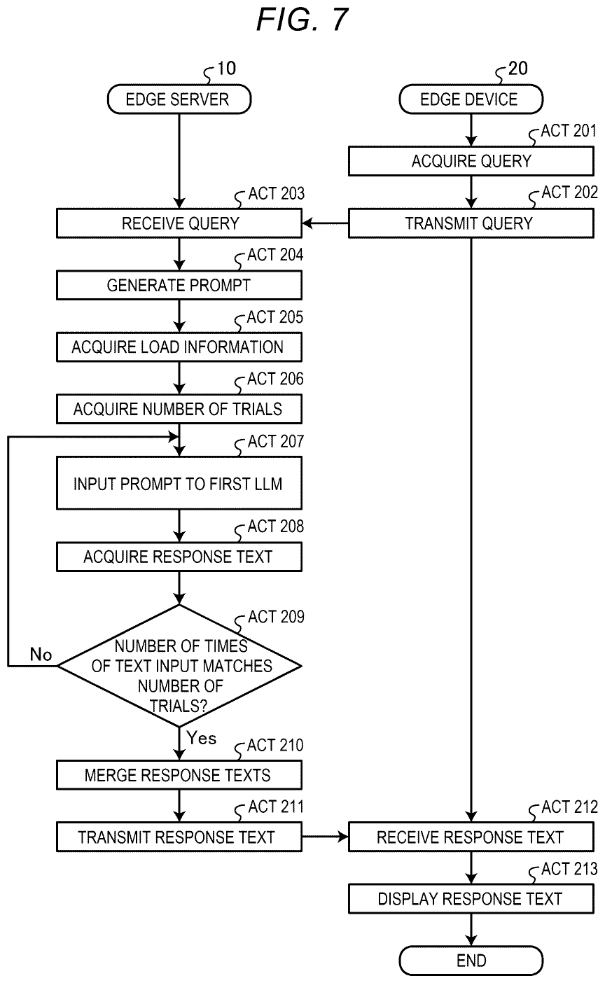

FIG. 7 is a flowchart showing an example of processing performed by each of the edge server 10 and the edge device 20 according to the first modification of the first embodiment. In FIG. 7 a processing example is shown for when a response text to a query is generated by the edge server 10 and provided to the edge device 20.

First, the query acquisition unit 2001 of the edge device 20 acquires the query input by the user (ACT 201). Next, the information transmission and reception unit 2002 of the edge device 20 transmits the acquired query to the edge server 10 (ACT 202).

The query reception unit 1001 of the edge server 10 receives the query transmitted from the edge device 20 (ACT 203). Next, the prompt generation unit 1002 of the edge server 10 generates a prompt based on the received query (ACT 204).

The machine load calculation unit 1003 of the edge server 10 acquires the usage rate of the CPU 101 as the load information (ACT 205). Next, the text generation control unit 1004 refers to the load information table 124 and acquires the number of trials corresponding to the acquired load information (ACT 206).

Subsequently, the text generation control unit 1004 of the edge server 10 inputs the prompt to the first LLM 122 (ACT 207). Then, the text generation control unit 1004 updates the number of text input times stored in the RAM 103.

Subsequently, the text generation control unit 1004 acquires the response text output by the first LLM 122 (ACT 208). Then, the text generation control unit 1004 temporarily stores the acquired response text in the RAM 103 as an x-th response text (x: the number of text input times). Next, the text generation control unit 1004 determines whether the number of text input times stored in the RAM 103 matches the number of trials (ACT 209).

When the number of text input times does not match the number of trials (ACT 209; No), the control unit 100 returns the processing to ACT 207.

When the number of text input times reaches the number of trials (ACT 209; Yes), the response provision unit 1005 of the edge server 10 acquires all the response texts stored in the RAM 103 and generates a response text by merging the response texts (ACT 210). Next, the response provision unit 1005 transmits the generated response text to the edge device 20 (ACT 211).

The information transmission and reception unit 2002 of the edge device 20 receives the response text from the edge server 10 (ACT 212). Next, the display control unit 2003 displays the response text on the display unit 206 (ACT 213).

As described above, the edge server 10 generates a prompt based on the input by the user and determines the number of times for inputting the prompt to the first LLM 122 according to the load status of the edge server 10. Then, the edge server 10 acquires a response text output by the first LLM 122.

Accordingly, the edge server 10 performs control such that response text generation is performed for a number of trials corresponding to the load status of the edge server 10. Therefore, it is possible to prevent the edge server 10 from being in a constantly high-load status and to prevent speed and efficiency in generating the response text from decreasing due to a resource shortage. In other words, it is possible to perform control to more efficiently generate a response to a query from the user according to the load status.

### Second Embodiment

Next, a second embodiment will be described. In this example, when the edge server 10 is in a high-load status, the edge server 10 may select a particular LLM to be used for generating the response text.

In some examples, by selecting the LLM to be used for generating the response text based on an attribute of the user or the like, it is possible to perform control to more efficiently generate a response to a query from the user.

In an embodiment, the first LLM 122 is a model that can generate a response with higher accuracy than the second LLM 123, in other words, the first LLM 122 is a model with higher performance than the second LLM 123.

In the second embodiment, an example will be described in which the user may be broadly classified into either a “general member” or a “premium member” as one example of an attribute of the user to be considered when selecting a particular LLM in a high-load status. When the user is a “premium member” the first LLM 122 (high-performance model) may be selected. When the user is “general member” the first LLM 122 (high-performance model) may be selected only when the edge server 10 is in the low-load status, and the second LLM 123 (low-performance model) is used otherwise, such as when the edge server 10 is in the high-load status.

Hereinafter, a configuration for determining the LLM to be used for generating a response text based on a user attribute and load information will be described.

In the second embodiment, the edge device 20 acquires a user ID, which is identification information that allows uniquely specifying the user, and transmits the user ID to the edge server 10 together with the query. Upon receiving the user ID and the query from the edge device 20, the edge server 10 acquires the user attribute corresponding to the user ID and thus can determine the LLM to be used for generating the response text based on the load information and the user attribute.

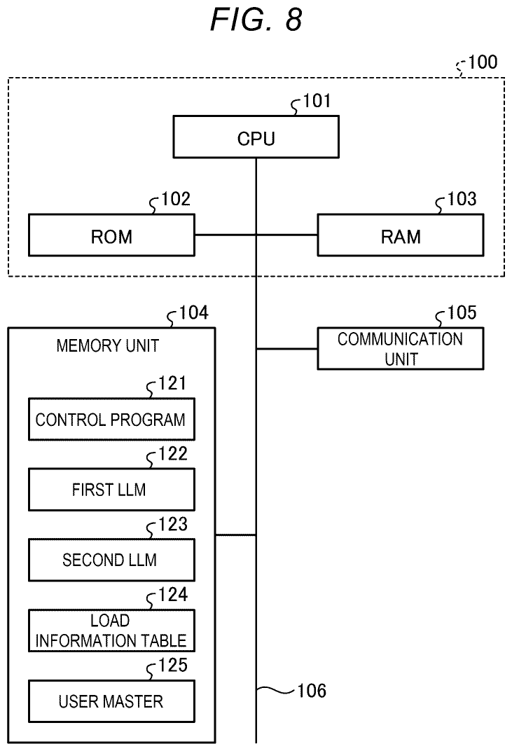

First, a hardware configuration of the edge server 10 in this embodiment will be described. FIG. 8 is a block diagram showing an example of the hardware configuration of the edge server 10 according to the second embodiment.

As shown in FIG. 8, the memory unit 104 of the edge server 10 includes a user master 125 in addition to the control program 121, the first LLM 122, the second LLM 123, and the load information table 124 already described above.

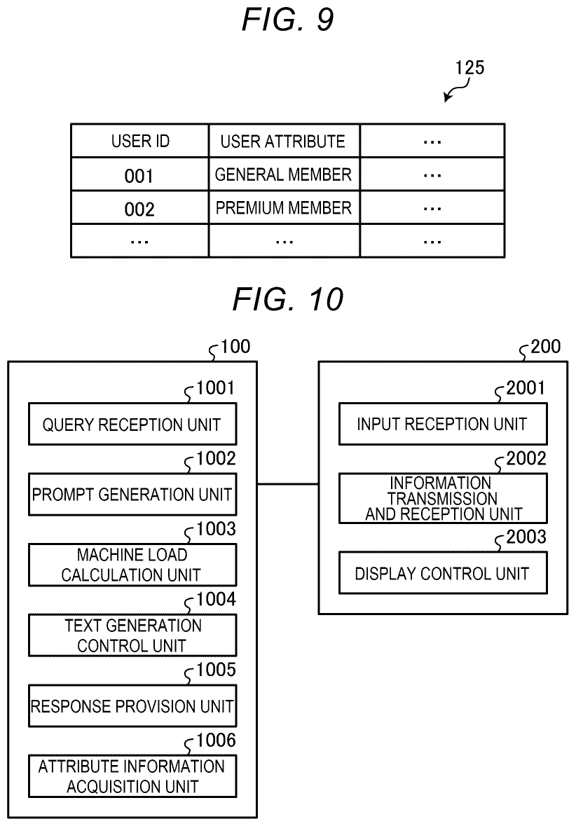

The user master 125 is a table or a database that stores the user's attributes in association with the user ID. FIG. 9 shows an example of a data configuration of the user master 125 according to the second embodiment. As shown in FIG. 9, the user master 125 stores information such as a user attribute in association with the user ID.

The user attribute is one example of attribute information. The user attribute is information indicating some characteristic or classification of the user. In FIG. 9, the user attribute indicates the use is either a “general member” or a “premium member”.

FIG. 10 is a block diagram showing an example of the functional configuration of the edge server 10 and the edge device 20 according to the second embodiment.

The edge server 10 also functions as an attribute information acquisition unit 1006 in addition to the query reception unit 1001, the prompt generation unit 1002, the machine load calculation unit 1003, the text generation control unit 1004, and the response provision unit 1005. The edge server 10 functions in this manner by the CPU 101 operating according to a control program stored in the ROM 102 or the memory unit 104. Each of the above-described functional configurations may be implemented by a hardware configuration such as a dedicated circuit. The edge device 20 is substantially the same as in the first embodiment.

The attribute information acquisition unit 1006 is an example of a third acquisition unit. The attribute information acquisition unit 1006 acquires the attribute information. Specifically, the attribute information acquisition unit 1006 refers to the user master 125 and acquires the user attribute corresponding to a user ID.

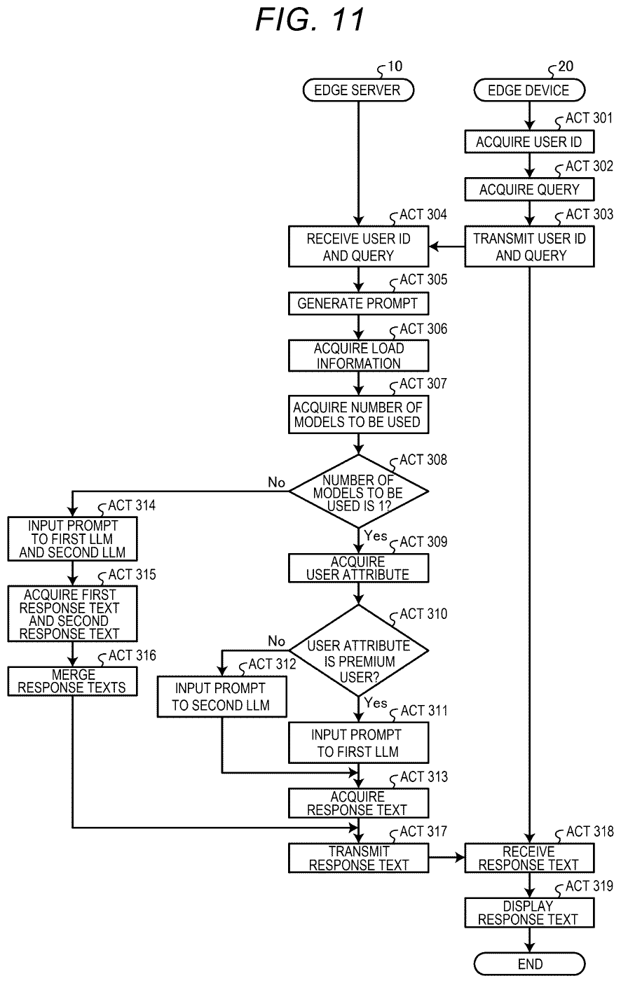

Next, control processing of the edge server 10 and the edge device 20 will be described with reference to FIG. 11.

FIG. 11 is a flowchart showing an example of the processing performed by the edge server 10 and the edge device 20 according to the second embodiment. FIG. 11 shows a processing example when the response text acquired by the edge device 20 is generated by the edge server 10.

First, the query acquisition unit 2001 of the edge device 20 acquires the user ID, such as input by user operation via the operation unit 207 (ACT 301). Next, the query acquisition unit 2001 acquires the query input by the user such as via the operation unit 207 (ACT 302). Then, the information transmission and reception unit 2002 transmits the acquired user ID and the query to the edge server 10 (ACT 303).

The query reception unit 1001 of the edge server 10 receives the user ID and the query from the edge device 20 (ACT 304). Next, the prompt generation unit 1002 generates a prompt including or reflected the received query (ACT 305).

The machine load calculation unit 1003 acquires the usage rate of the CPU 101 as the load information (ACT 306). Next, the text generation control unit 1004 refers to the load information table 124 and acquires the number of models to be used for the acquired load information (ACT 307). Next, the text generation control unit 1004 determines whether the number of models to be used is “1” (ACT 308).

When the number of models to be used is “1” (ACT 308; Yes), the attribute information acquisition unit 1006 refers to the user master 125 and acquires a user attribute corresponding to the user ID (ACT 309). Then, in this example, the text generation control unit 1004 determines whether the user attribute indicates a “premium member”(ACT 310).

When the user is a “premium member” (ACT 310; Yes), the text generation control unit 1004 inputs the prompt to the first LLM 122 (ACT 311). Then, the control unit 100 proceeds with the processing to ACT 313.

When the user is a “general member” (ACT 310; No), the text generation control unit 1004 inputs the prompt to the second LLM 123 (ACT 312). The text generation control unit 1004 acquires the response text output by the first LLM 122 or the second LLM 123 (ACT 313). Then, the control unit 100 proceeds with the processing to ACT 317.

When the number of models to be used is “2” (ACT 308; No), the text generation control unit 1004 inputs the prompt to the first LLM 122 and the second LLM 123 (ACT 314). The text generation control unit 1004 thus acquires a first response text and a second response text as respectively output by the first LLM 122 and the second LLM 123 (ACT 315). Then, the response provision unit 1005 of the edge server 10 acquires a response text obtained by merging the first response text and the second response text (ACT 316).

Subsequently, the response provision unit 1005 transmits the response text to the edge device 20 (ACT 317).

The information transmission and reception unit 2002 of the edge device 20 receives the response text from the edge server 10 (ACT 318). The display control unit 2003 then displays the received response text on the display unit 206 (ACT 319).

In ACT 301, the query acquisition unit 2001 may acquire the user ID from a storage medium such as a membership card being read by an imaging unit, an RF reading unit, or the like provided in the edge device 20.

As described above, the edge server 10 of the second embodiment further includes the attribute information acquisition unit 1006 that acquires the user attribute information, and the text generation control unit 1004 determines which LLM to which the prompt is to be input based on the load information and the attribute information.

Accordingly, the edge server 10 selects the LLM to which the prompt is to be input according to the attribute information, and performs control to generate a response text. Therefore, by changing the number of models or the model type to be used according to the attribute information, it is possible to prevent the edge server 10 from being in a constantly high-load status, and to prevent speed and efficiency of generating the response text from decreasing due to a resource shortage. In other words, it is possible to perform control to more efficiently generate a response to a query from the user according to the load status.

### Second Modification

In the second embodiment, the text generation control unit 1004 selects the LLM to which the prompt is to be input according to a user attribute acquired by the attribute information acquisition unit 1006 from the user master 125, but the disclosure is not limited thereto, and the text generation control unit 1004 may select the LLM to which the prompt is to be input according to an attribute in the prompt that may be extracted by the attribute information acquisition unit 1006.

For example, when the attribute information acquisition unit 1006 identifies that a language in which the prompt is written is Japanese, the text generation control unit 1004 may select the LLM to which the prompt is to be input based on the extracted prompt attribute such that an LLM having an excellent Japanese processing capability is preferentially used in a high-load status or otherwise.

Accordingly, since it can be expected that the response text will be more quickly generated, the edge server 10 can perform control to more efficiently generate a response to a query from the user.

### Third Modification

In an embodiment, the prompt generation unit 1002 of the edge server 10 generates a prompt based on the query received by the query reception unit 1001 of the edge server 10, but the disclosure is not limited thereto. For example, the prompt generation unit 1002 may instead be provided in the edge device 20. In this case, the edge server 10 receives the prompt generated by the prompt generation unit 1002 of the edge device 20.

### Fourth Modification

In an embodiment, the query acquisition unit 2001 of the edge device 20 acquires the query input by a user operation via the operation unit 207, but the disclosure is not limited thereto. For example, the query acquisition unit 2001 of the edge device 20 may convert voice received from a voice input device such as a microphone provided in the edge device 20 into text data and acquire the text data for the query in this manner.

### Fifth Modification

In the second embodiment, the edge server 10 includes the first LLM 122 and the second LLM 123, but is not limited thereto. Even when the edge server 10 includes just one LLM, it may be expected that the same or similar advantageous effect as that described for the second embodiment can be obtained by, for example, changing the number of trials (repeated of inputting the prompt to the LLM) for a user whose user attribute is “general member” as compared to a user whose user attribute is “premium member”. In this case, it may be preferable to set the number of trials for a “premium member” to be larger than the number of trials for a “general member”in the load information table 124.

Programs executed by the information processing system 1 according to the embodiments and the modifications may be stored on a computer connected to a network, such as the Internet, and provided by being downloaded via the network. In addition, the programs executed by the information processing system 1 may be accessed or distributed across a network such as the Internet.

The programs executed in various embodiments may be incorporated in advance in a ROM, a storage unit, or the like or recorded in a non-transitory, computer-readable recording medium such as a CD-ROM, a flexible disk (FD), a CD-R, or a digital versatile disk (DVD) as a file in an installable or executable format.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus, comprising:
a storage unit;
a communication unit; and
a control unit configured to:
receive a query text via the communication unit;
generate a prompt based on the query text;
acquire present load status information corresponding to a current workload of the control unit;
determine a number of generative AI models to which the generated prompt is to be input based at least in part on the present load status information;
receive a response text from the determined number of generative AI models; and
output a query response text via the communication unit, the query response text reflecting each received response text.

2. The information processing apparatus according to claim 1, wherein, when the present load status information indicates the current workload of the control unit is high, the determined number of generative AI models to which the generated prompt is to be input is one.

3. The information processing apparatus according to claim 2, wherein, when the present load status information indicates the current workload of the control unit is low, the determined number of generative AI models to which the generated prompt is to be input is greater than one.

4. The information processing apparatus according to claim 1, wherein, when the present load status information indicates the current workload of the control unit is low, the determined number of generative AI models to which the generated prompt is to be input is greater than one.

5. The information processing apparatus according to claim 1, wherein the number of generative AI models to which the generated prompt is to be input is further based on a user attribute of a user sending the query text.

6. The information processing apparatus according to claim 1, wherein the number of generative AI models to which the generated prompt is to be input is determined by reference to a load information table stored in the storage unit, the load information table associating the number of generative AI models to which the generated prompt is to be input to different values of the present load status information.

7. The information processing apparatus according to claim 1, wherein
the storage unit stores a first generative AI model and a second generative AI model,
the prompt is input to both the first and second generative AI models when the present load status information indicates the current workload of the control unit is low, and
the prompt is input to only the first generative AI model when the present load status information indicates the current workload of the control unit is high.

8. The information processing apparatus according to claim 1, wherein
the storage unit stores a first generative AI model and a second generative AI model having a different response accuracy from the first generative AI model, and
the control unit is further configured to select between inputting the generated prompt to one of the first or second generative AI model based on a user attribute of the user sending the query text and the present load status information.

9. The information processing apparatus according to claim 1, wherein the current workload is a processor utilization rate for a processor in the control unit.

10. An information processing apparatus, comprising:
a storage unit;
a communication unit; and
a control unit configured to:
receive a query text via the communication unit;
generate a prompt based on the query text;
acquire present load status information corresponding to a current workload of the control unit;
determine a number of times the generated prompt is to be input to a generative AI model based at least in part on the present load status information;
receive a response text for each time generated prompt is input the generative AI model; and
output a query response text via the communication unit, the query response text reflecting each received response text.

11. The information processing apparatus according to claim 10, wherein, when the present load status information indicates the current workload of the control unit is high, the determined number of times is less than the determined number of times when the present load status information indicates the current workload of the control unit is not high.

12. The information processing apparatus according to claim 10, wherein the number of times is further based on a user attribute of a user sending the query text.

13. The information processing apparatus according to claim 10, wherein the number of times is determined by reference to a load information table stored in the storage unit, the load information table associating the number of times the generated prompt is to be input to different values of the present load status information.

14. The information processing apparatus according to claim 10, wherein
the storage unit stores a first generative AI model and a second generative AI model having a different response accuracy from the first generative AI model, and
the control unit is further configured to select between inputting the generated prompt to one of the first or second generative AI model based on a user attribute of the user sending the query text.

15. An information processing method, comprising:
receiving a query text via a communication unit;
generating a prompt based on the query text;
acquiring present load status information corresponding to a current workload of a control unit of an information processing apparatus;
determining either a number of generative AI models to which the generated prompt is to be input based at least in part on the present load status information or a number of times the generated prompt is to be input to a generative AI model at least in part on the present load status information;
receiving a response text from the determined number of generative AI models or for each of the determined number of times; and
outputting a query response text via the communication unit, the query response text reflecting each received response text.

16. The information processing method according to claim 15, wherein the number of generative AI models to which the generated prompt is to be input is determined to be greater than one when the present load status information indicates the current workload is a low level.

17. The information processing method according to claim 16, wherein the query response text is merging of each response text.

18. The information processing method according to claim 15, wherein the number of times the generated prompt is to be input to the generative AI model is determined to be greater than one when the present load status information indicates the current workload is a low level.

19. The information processing method according to claim 18, wherein the query response text is merging of each response text.

20. The information processing method according to claim 15, wherein the number of times or the number of generative AI models is determined by reference to a load information table stored in the storage unit, the load information table associating the number of times the generated prompt is to be input to different values of the present load status information or the number of generative AI models to which the generated prompt to be input to different values of the present load status information.
